(19) United States
(12) Patent Application Publication
(10) Pub. No.: US 2024/0129818 A1
(43) Pub. Date: Apr. 18, 2024

(54) RADIO BASE STATION AND TERMINAL

(71) Applicant: NTT DOCOMO, INC., Tokyo (JP)

(72) Inventors: Tianyang Min, Tokyo (JP); Yuya Hoshizaki, Tokyo (JP); Tadashi Uchiyama, Tokyo (JP); Shinsuke Sawamukai, Tokyo (JP); Anil Umesh, Tokyo (JP)

(73) Assignee: NTT DOCOMO, INC., Tokyo (JP)

(21) Appl. No.: 18/271,819

(22) PCT Filed: Jan. 12, 2021
(86) PCT No.: PCT/JP2021/000731

§ 371 Date: Jul. 11, 2023

(51) Int. Cl. H04W 36/00

(52) U.S. Cl. CPC H04W 36/00833; H04W 36/0079

(57) ABSTRACT

A radio base station receives a handover message from a network related to a handover of a terminal and determines the number of handover failures based on a number of the handover failures based on the handover message. The radio base station releases the terminal when the number of failures reaches a predetermined number.

### TECHNICAL FIELD

The disclosure relates to a radio base station and a terminals that perform handovers via an S1 interface.

### BACKGROUND ART

The 3rd Generation Partnership Project (3GPP) has specified the Long Term Evolution (LTE), the 5th generation mobile communication system (Also known as 5G, New Radio (NR) or Next Generation (NG)), and is also in the process of specifying the next generation called Beyond 5G, 5G Evolution or 6G.

The LTE and NR stipulate handover of a terminal (User Equipment, UE) using an interface (S1) between a radio base station (eNB/gNB) and a network device (Mobility Management Entity (MME)/Access and Mobility Management Function (AMF)) (For example, non-patent literature 1).

### CITATION LIST

### Non-Patent Literature

3 GPP TS 36.413 V 16.4.0, 3rd Generation Partnership Project; Technical Specification Group Radio Access Network; Evolved Universal Terrestrial Radio Access Network (E-UTRAN); S1 Application Protocol (S1AP) (Release 16), 3GPP, January 2021

### SUMMARY OF INVENTION

In the handover via the S1 interface, if the handover to the target radio base station (cell) at the handover destination fails repeatedly (Specifically, eight times), the value of the counter called NCC (Next Hop (NH) Chaining Counter) reaches the upper limit and occurs a warp around returning to the initial value.

However, the UE does not recognize the wraparound of the counter value. Therefore, there is a problem that the encryption key using the NH parameter before wraparound possessed by the UE (ciphering key, K_{eNB}) does not match the encryption key using the NH parameter after wraparound possessed by the target radio base station. Such problems are particularly likely to occur with aerial UEs such as drones.

Therefore, the following disclosure has been made in view of such circumstances, and aims to provide a radio base station and a terminal that can avoid mismatching of encryption keys used even when handovers fail consecutively over multiple times.

One aspect of the disclosure is a radio base station (radio base station 100) including a reception unit (handover processing unit 120) that receives a handover message from a network related to a handover of a terminal (UE 200), and a control unit (control unit 140) that determines a number of the handover failures based on the handover message. The control unit releases the terminal when the number of failures reaches a predetermined number.

One aspect of the disclosure is a radio base station (radio base station 100) including a control unit (control unit 140) that controls transmitting and receiving of handover messages related to a handover of a terminal (UE 200), a reception unit (handover processing unit 120) that receives a handover message from the network, including a wraparound indication indicating that a counter value related to the handover has wraparound, and a transmission unit (RRC processing unit 130) that transmits a reconfiguration message including the wraparound indication to the terminal, when receiving the handover message including the wraparound indication.

One aspect of the disclosure is a radio base station (radio base station 100) including a transmission unit that transmits a handover message to a network related to a handover of a terminal (UE 200), a reception unit (handover processing unit 120) that receives a handover message from the network including a wraparound indication indicating that a counter value related to the handover has wrapped around, and a control unit (control unit 140) that releases the terminal when the wraparound indication is received.

One aspect of the disclosure is a radio base station (radio base station 100) including a reception unit (handover processing unit 120) that receives a handover message from a network related to a handover of a terminal (UE 200), and a control unit (control unit 140) that changes configuration related to a measurement object of the terminal when a number of reception times of the handover message reaches a predetermined value.

One aspect of the disclosure is a terminal (UE 200) including a reception unit (radio communication unit 210) that receives a reconfiguration message from a network, and a control unit (control unit 240) that updates a parameter used to generate a cryptographic key used in a handover based on a wraparound indication if the reconfiguration message includes the wraparound indication indicating that a counter value related to the handover has wrapped around.

### BRIEF DESCRIPTION OF DRAWINGS

FIG. 1 is an overall schematic configuration diagram of radio communication system 10.

FIG. 2 is a functional block diagram of the radio base station 100. Fig.

FIG. 3 is a functional block diagram of the UE 200.

FIG. 4 shows an example of a communication sequence in which the encryption key held by the UE 200 and the encryption key held by the target radio base station are mismatched in an S1 handover.

FIG. 5 is a diagram showing an example communication sequence related to the generation of an encryption key owned by the UE 200 and an encryption key owned by the target radio base station.

FIG. 6 is a diagram showing the operation flow of the source radio base station according to operation example 1.

FIG. 7 is a diagram showing an example communication sequence of the S1 handover in operation example 2.

FIG. 8 is a diagram showing an example communication sequence of the S1 handover in operation example 3.

FIG. 9 is a diagram showing the operation flow of the source radio base station according to operation example 4.

FIG. 10 is a diagram showing the operation flow of the source radio base station according to operation example 5.

FIG. 11 shows an example communication sequence of the S1 handover in operation example 6.

FIG. 12 shows an example of the hardware configuration of the network device 40, the radio base station 100 and the UE 200.

### MODES FOR CARRYING OUT THE INVENTION

Exemplary embodiments of the present invention are explained below with reference to the accompanying drawings. Note that, the same or similar reference numerals have been attached to the same functions and configurations, and the description thereof is appropriately omitted.

### (1) Overall Schematic Configuration of the Radio Communication System

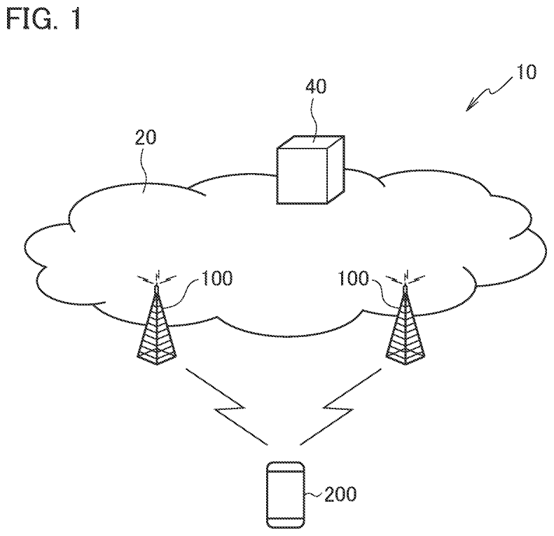

FIG. 1 is an overall schematic diagram of a radio communication system 10 according to the present embodiment. The radio communication system 10 is a radio communication system according to Long Term Evolution (LTE) or 5G New Radio (NR) and includes a radio access network 20 and terminals 200 (User Equipment 200, below, UE 200).

The UE 200 may be an aerial UE (aerial terminal) mounted on a drone or the like. Drones and other unmanned aerial objects could be called Unmanned Aerial Vehicles (UAV), for example.

The radio access network 20 is an Evolved Universal Terrestrial Radio Access Network (E-UTRAN) or NG-RAN defined in 3 GPP and includes radio base stations 100 (eNB or gNB).

The radio communication system 10 may be a radio communication system according to a scheme called Beyond 5G, 5G Evolution or 6 G. Further, the specific configuration of the radio communication system 10 including the number of gNB/eNB and UE is not limited to the example shown in FIG. 1.

A network device 40 is connected to the radio access network 20. The network device 40 may be referred to as a mobility management entity or communication node (function) that manages the mobility of the UE 200. Specifically, the network device 40 may be a mobility management entity (MIME) or an access and mobility management function (AMF).

The radio access network 20 and the network device 40 may simply be described as a “network.”

As described above, the radio base station 100 is a radio base station in accordance with LTE or NR and performs radio communication with the UE 200 in accordance with LTE or NR.

By controlling the radio signals transmitted from the multiple antenna elements, the radio base stations 100 and UE 200 can support Massive MIMO for generating a more directional beam, carrier aggregation (CA) for bundling multiple component carriers (CCs), and dual connectivity (DC) for simultaneously communicating between the UE and each of the multiple NG-RAN nodes.

Also, the radio communication system 10 may support handover of the UE 200 through the S1 interface between the radio base station 100 and the network device 40. Specifically, a handover message (handover message) is transmitted and received between the radio base station 100 and the network device 40, and handover can be performed from the handover source (source) radio base station (which may be called a cell) to the handover destination (target) radio base station.

More specifically, the radio communication system 10 may send and receive various handover messages in accordance with S1-AP (Application). Such handover messages may include Handover Required, Handover Request, Handover Request Ack, Handover command, Handover Failure, Handover Preparation Failure, etc.

### (2) Function Block Configuration of Radio Communication System

Next, the functional block configuration of the radio communication system 10 is described. Specifically, the functional block configuration of the radio base station 100 and the UE 200 is described.

### (2.1) Radio Base Station 100

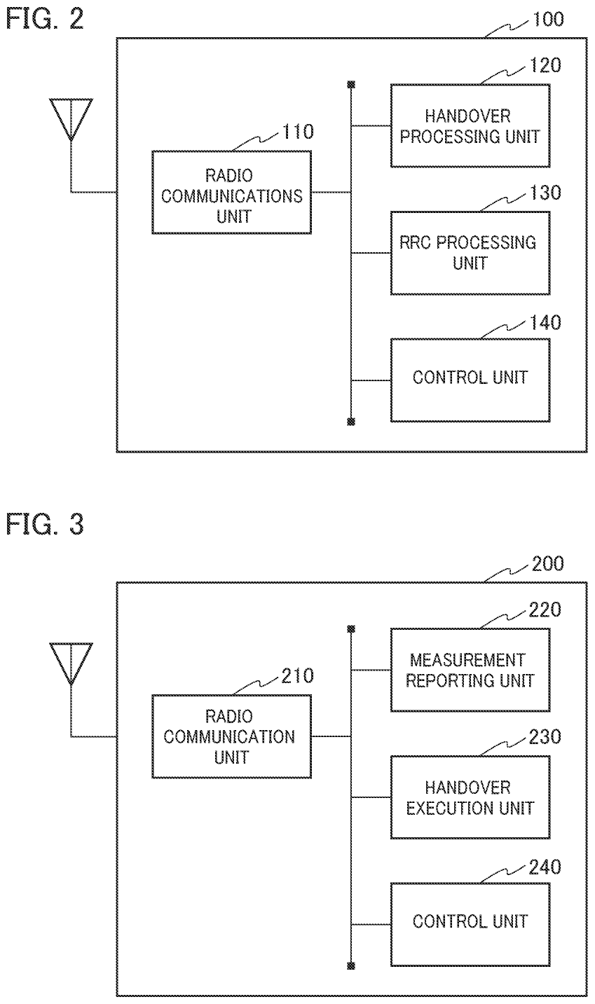

FIG. 2 is a functional block diagram of the radio base station 100. As shown in FIG. 2, the radio base station 100 includes a radio communication unit 110, a handover processing unit 120, an RRC processing unit 130 and a control unit 140. The radio base station 100 may function as a source or target radio base station for handovers.

The radio communication unit 110 transmits a downlink signal (DL signal). The radio communication unit 110 also receives an uplink signal (UL signal).

The handover processing unit 120 performs processing related to the handover of the UE 200. Specifically, the handover processing unit 120 performs processing related to the handover (which may be referred to as the S1 handover) via the S1 interface.

Specifically, in this embodiment, the handover processing unit 120 receives a handover message related to the handover of the UE 200 from the network. In this embodiment, the handover processing unit 120 may configure a reception unit to receive a handover message from the network. Specifically, the handover processing unit 120 can receive a Handover Preparation Failure message (msg.) from the network device 40.

The handover processing unit 120 can also receive a Handover command message from the network device 40. The Handover command may include a wraparound indication indicating that the counter value for the handover has wrapped around.

The counter value for the handover may be interpreted as, for example, the value of NCC (Next Hop (NH) Chaining Counter). The value of NCC may be incremented by one if the handover to the target radio base station fails.

The range of values that NCC may take is not particularly limited but may be, for example, 0˜7. If the value of NCC reaches the upper limit (For example, “7”), it may return to the initial value of 0. In this way, it may be expressed that the counter value wraps around when the NCC value returns to the initial value and counts again, and wrap around indication may be used to indicate that the NCC has wrapped around.

That is, the handover processing unit 120 can receive from the network a Handover command message containing a wraparound indication that the counter value (NCC value) for handover has wrapped around.

The handover processing unit 120 can also send a Handover Required message to the network device 40. The Handover Required may be interpreted as a handover request sent to the network device 40 in response to a measurement report sent from the UE 200.

The RRC processing unit 130 performs various processing in the radio resource control layer (RRC). Specifically, the RRC processing unit 130 can send and receive various RRC messages to and from the UE 200.

In particular, in this embodiment, the RRC processing unit 130 can send an RRC Reconfiguration (reconfiguration message) to the UE 200 upon handover. The RRC processing unit 130 can also receive an RRC Reconfiguration Complete, which is a response to the RRC Reconfiguration, from the UE 200.

The name of the RRC message may be RRC Connection Reconfiguration or RRC Connection Reconfiguration Complete.

When the handover processing unit 120 receives a Handover command message containing wrap around indication, the RRC processing unit 130 can send an RRC Reconfiguration containing wrap around indication to the UE 200. In this embodiment, the RRC processing unit 130 may configure a transmission unit that sends a reconfiguration message containing wrap around indication to the terminal.

The control unit 140 controls each function block that constitutes the radio base station 100. Specifically, in this embodiment, the control unit 140 performs control regarding the handover of the UE 200 through the S1 interface.

Specifically, the control unit 140 controls the transmission and reception of handover messages related to the handover of the UE 200, such as Handover Required, Handover command, etc.

Also, the control unit 140 can determine the number of handover failures based on the Handover Preparation Failure message. Specifically, the control unit 140 may count the number of handover Preparation Failure messages received and determine the number of handover failures. The upper limit value (specified number of times) of the counter that counts the number of Handover Preparation Failure messages received may be set to, for example, “8” to match the values that NCC can take.

The control unit 140 may release the UE 200 when the number of handover failures reaches the specified number.

The control unit 140 may also release the UE 200 when the handover processing unit 120 receives the wrap around indication included in the Handover Preparation Failure message.

Specifically, the control unit 140 causes the RRC processing unit 130 to send an RRC message and releases the connection of the UE 200 to the network. For example, RRC Release or RRC Connection Release may be used as the RRC message.

In addition, the control unit 140 may change the configuration regarding the measurement object (measObject) of the UE 200 when the number of times the Handover Preparation Failure message is received reaches the specified value.

Specifically, the control unit 140 may delete the measObjectID (The target cell of the handover, that is, the frequency band that had been set by mobilityControlInfo or reconfigurationWithSync (see 3 GPP TS 38.331)) that was set (configured) for the UE 200.

Alternatively, the control unit 140 may, when the number of times the Handover Preparation Failure message has been received reaches a specified value, add as a source radio base station (cell) the Handover Preparation Failure message and the corresponding handover destination cell as non-target cells (which may be called black cells) in the measObject.

In addition, the specified value for the number of times the Handover Preparation Failure message is received may be less than 8, for example 7 or less, considering the value that NCC can take.

The control unit 140 may also determine whether the UE 200 is an aerial UE. If the UE 200 is an aerial UE, the control unit 140 may exclude the frequency band where the aerial UE is limited from the measurement target of the UE 200. That is, the UE 200 may exclude the frequency band from the measurement report target.

### (2.2) UE 200

FIG. 3 is a functional block diagram of the UE 200. As shown in FIG. 3, the UE 200 includes a radio communication unit 210, a measurement reporting unit 220, a handover execution unit 230 and a control unit 240.

The radio communication unit 210 transmits an uplink signal (UL signal) in accordance with LTE or NR. The radio communication unit 210 also receives a downlink signal (DL signal) in accordance with LTE or NR.

Specifically, the radio communication unit 210 may send and receive various messages of RRC. Specifically, the radio communication unit 210 can receive RRC Reconfiguration from the network (radio base station 100) and transmit RRC Reconfiguration Complete to the network (radio base station 100). In this embodiment, the radio communication unit 210 may configure a reception unit to receive the reconfiguration message from the network.

As described above, the name of the RRC message may be RRC Connection Reconfiguration or RRC Connection Reconfiguration Complete.

The measurement report unit 220 can measure the quality of the serving cell of the UE 200 and neighboring cell (neighbor cell) of the serving cell and report the measurement report to the network. The measurement reporting unit 220 may execute measurement reports of the source and target cells upon handover.

The quality of the measurement target may be, for example, the quality (For example, Reference Signal Received Power (RSRP), Reference Signal Received Quality (RSRQ)) included in the measurement report specified in 3 GPP TS 38.331.

The handover execution unit 230 executes the handover of the UE 200. In particular, in this embodiment, the handover execution unit 230 can execute the S1 handover.

Specifically, the handover execution unit 230 can execute the handover from the source radio base station (cell) to the target radio base station (cell) based on the handover command (RRC Reconfiguration) transmitted from the network.

The control unit 240 controls each functional block that constitutes the UE 200. Specifically, in this embodiment, the control unit 240 performs control over the handover of the UE 200 through the S1 interface.

Specifically, if the reconfiguration message (For example, RRC Reconfiguration) contains a wraparound indication that the counter value (NCC) for the handover has wrapped around, the control unit 240 may update the parameters used for generating the encryption key (For example, K_{eNB}) used in the handover based on the wrap around indication.

The parameters used for generating the encryption key may be interpreted as Next Hop (NH) parameters. Handling of the encryption key (K_{eNB}) using NH is specified in Section 7.2.8 (key handling in handover) of 3 GPP T 33.401.

Specifically, when the control unit 240 receives a wraparound indication, it may update the NH by the amount of wraparound (1 wraparound indication is 8 times).

More specifically, the control unit 240 may increase the value of the retained NCC to the same value as the NCC contained in the Handover command and calculate K_{eNB}* using the Physical Cell ID (target PCI) of the target radio base station and the EARFCN-DL (E-Absolute Radio-Frequency Channel Number-Downlink) of the frequency. The Handover command may also include the number of times the NCC value has wrapped around.

### (3) Operation of Radio Communication System

Here's how radio communication system 10 works. Specifically, operation related to the S1 handover will be described.

### (3.1) Assumptions

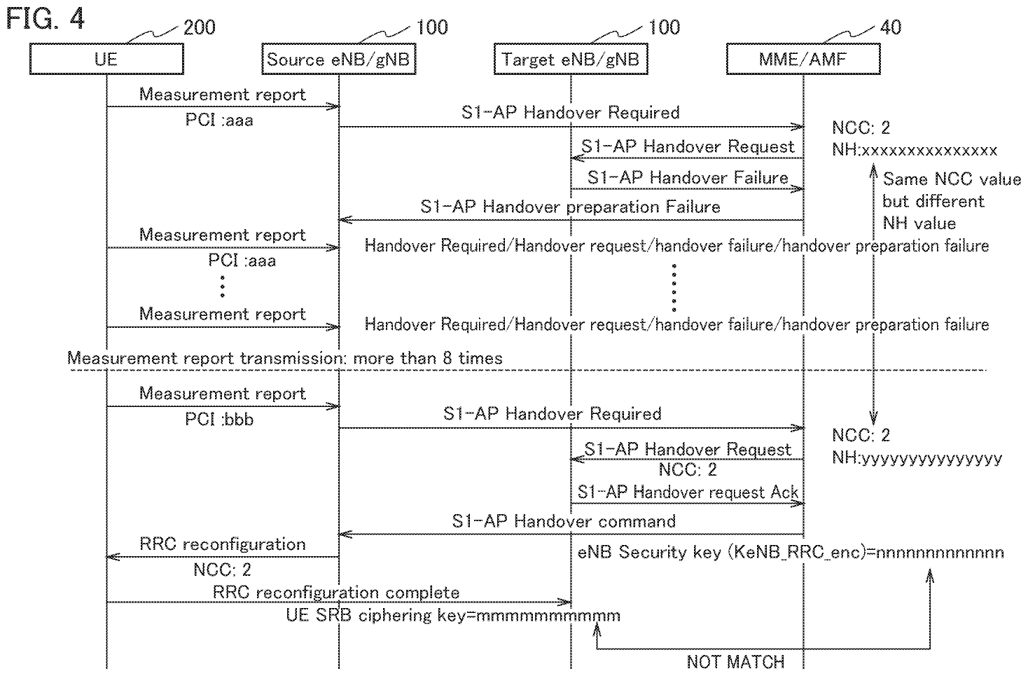

FIG. 4 shows an example of a communication sequence in which the encryption key held by the UE 200 and the encryption key held by the target radio base station are mismatched in an S1 handover.

As shown in FIG. 4, in the S1 handover of the UE 200, if a handover failure (including Handover Preparation Failure) occurs multiple times (For example, eight or more times) in which handover to the target radio base station fails, the ciphering key used in the RRC Reconfiguration Complete transmitted to the candidate target radio base station (cell) 200 after the multiple handover failures may not match the encryption key held by the target radio base station.

Such problems can also occur in LTE (Release 8 and later) and NR (Release 15 and later). Normally, the upper limit of NCC is “7,” so it is difficult to assume that handovers will fail more than eight times, but in the case of an aerial UE, handovers may fail consecutively because the outlook and other conditions are different from those of a normal UE.

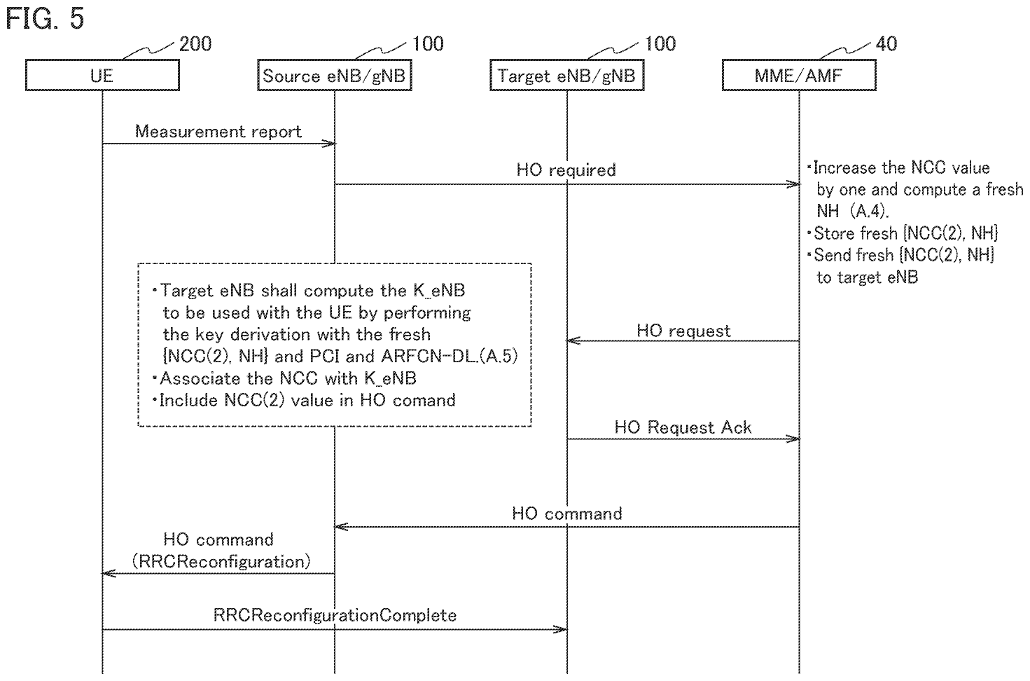

FIG. 5 shows an example of a communication sequence for generating an encryption key owned by the UE 200 and an encryption key owned by the target radio base station.

As shown in FIG. 5, each time the source radio base station (eNB/gNB) sends the Handover Required to the network device 40 (MME/AMF), the network device 40 increments the NCC value by one and calculates a new NH value.

When the source radio base station sends the Handover Required to the network device 40 8 or more times, the NCC value on the network device 40 side wraps around (If NCC value={0 . . . 7}).

Even if the NCC value included in the Handover command wraps around, the UE 200 is not able to recognize the wraparound. Therefore, if the notified NCC value is the same as the stored NCC value, the UE 200 uses the K_{eNB} generated using the NCC value to generate a K_{eNB}*. The K_{eNB}* is generated using target PCI and EARFCN-DL as described above. On the other hand, when the notified NCC value is different from the stored NCC value, the UE 200 increases (counts up) the NCC value to the NCC value and generates the K_{eNB}*using the updated NH value.

Thus, even if the NCC value wraps around, the UE 200 is unable to update the NCC value to the NH value when the NCC value wraps around, which causes a ciphering key mismatch between the UE 200 and the target radio base station.

### (3.2) Example of Operation

Next, an example of operation that can resolve the above ciphering key mismatch will be described. Specifically, an example of operation 1-6 will be described.

### (3.2.1) Operation Example 1

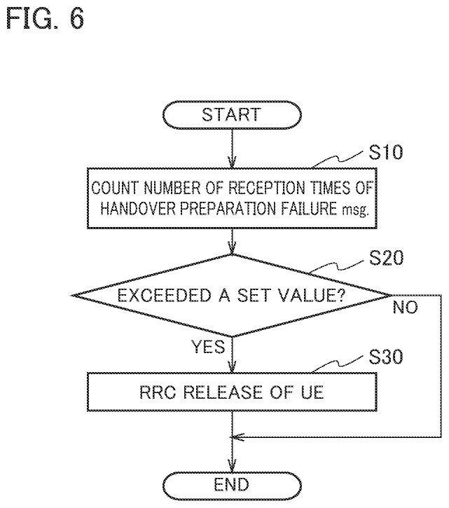

FIG. 6 shows the operation flow of the source radio base station according to Operation Example 1. As shown in FIG. 6, the source radio base station (radio base station 100) counts the number of reception times of Handover Preparation Failure msg. (S10).

For example, the radio base station 100 may provide a counter to count the number of times of such reception. Alternatively, information indicating the number of times of such reception may be included in the Handover Preparation Failure. The upper limit of the number of times of reception is not particularly limited, but it is desirable to determine it by taking into account the value that the NCC can take. For example, the upper limit (set value) may be set to “8.”

The radio base station 100 determines whether or not the number of reception has exceeded a set value (which may be called a specified value) (S 20).

If the number of reception has exceeded the set value, the radio base station 100 may release the UE 200 (RRC Release) (S 30). Specifically, the radio base station 100 may send an RRC Release (or RRC Connection Release) to the UE 200.

### (3.2.2) Operation Example 2

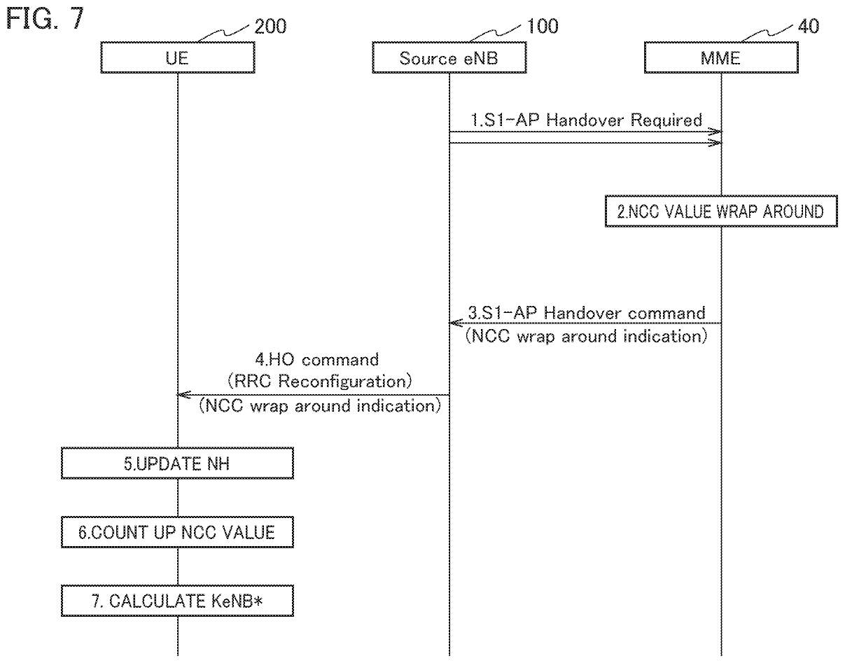

FIG. 7 shows an example communication sequence of the S1 handover according to Operation Example 2. As shown in FIG. 7, the source radio base station (radio base station 100) transmits the Handover Required msg. to the network device 40 multiple times consecutively (step 1). In FIG. 7, eNB and MME are shown, but in the case of NR, they may be replaced by gNB and AMF, respectively (hereafter the same).

The network device 40 wraps around the NCC value by receiving multiple Handover Required messages (step 2).

When the network device 40 wraps around the NCC value, it may send a Handover command containing the wrap around indication of the NCC to the radio base station 100 (step 3).

The radio base station 100 may send a Handover command containing the wrap around indication of the NCC (RRC Reconfiguration) to the UE 200 (step 4).

When the UE 200 receives the wrap around indication, it updates the NH (step 5) by the time the NCC wraps around (one lap is 8 times). Furthermore, the UE 200 may increase (count up) the value of the held NCC (NCC value) to the same value as the NCC included in the handover command (step 6) and calculate K_{eNB}*using target PCI and EARFCN-DL (step 7). The handover command may include the number of times the NCC value has wrapped around.

### (3.2.3) Operation Example 3

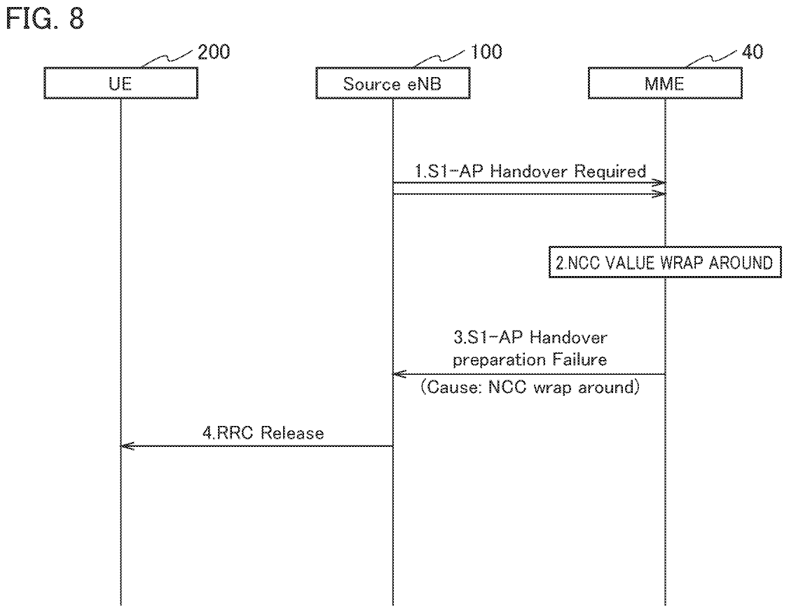

FIG. 8 shows an example communication sequence of the S1 handover according to Example 3. Steps 1 and 2 in FIG. 8 are the same as in Example 2 (see FIG. 7).

When the network device 40 wraps around the NCC value, it may send a Handover Preparation Failure msg. containing the wrap around indication of the NCC to the radio base station 100 (Step 3). Specifically, the wraparound of the NCC may be included as a cause of the Handover Preparation Failure.

When the radio base station 100 receives the Handover Preparation Failure msg., it may release the UE 200 (RRC Release) (Step 4). Specifically, the radio base station 100 may send the RRC Release (or RRC Connection Release) to the UE 200.

### (3.2.4) Operation Example 4

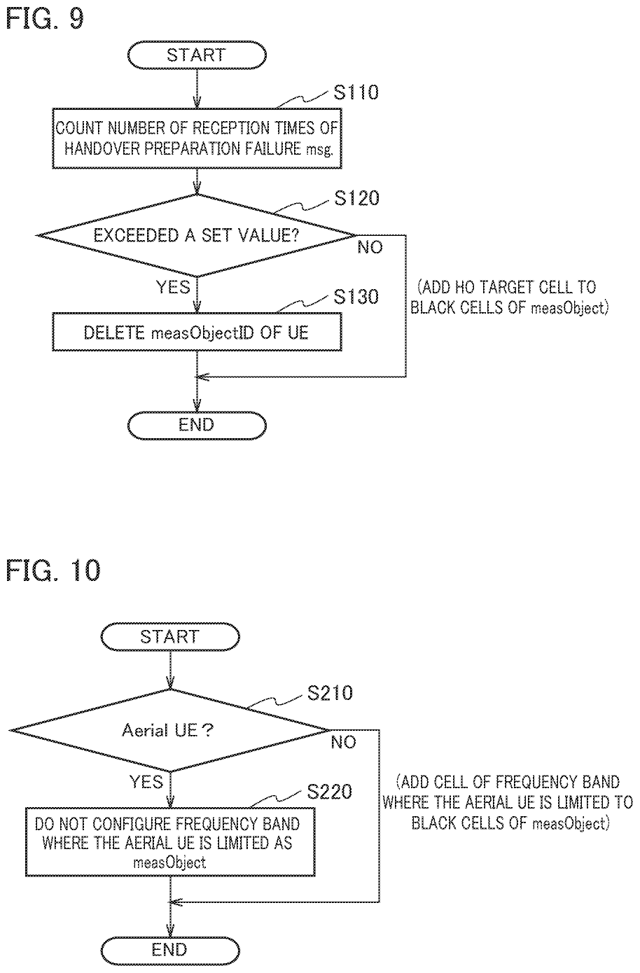

FIG. 9 shows the operation flow of the source radio base station according to Operation Example 4. As shown in FIG. 9, the source radio base station (radio base station 100) counts the number 110 of times Handover Preparation Failure msg. The method for counting the number of times Handover Preparation Failure msg.

The radio base station 100 determines whether or not the number of times of reception exceeds a set value (which may be called a specified value) (S 120).

If the number of times of reception exceeds a set value, the radio base station 100 may delete the measObjectID of the UE 200 subject to the handover (S 130). Specifically, the radio base station 100 may delete the measObjectID (The target cell of the handover, that is, the frequency band that had been set by mobilityControlInfo or reconfigurationWithSync (see 3 GPP TS 38.331)) set (configured) for the UE 200.

Alternatively, as a source radio base station (cell), the radio base station 100 may add a Handover Preparation Failure message and the corresponding cell of the handover destination as non-target cells (may be called black cells) in the measObject.

### (3.2.5) Operation Example 5

FIG. 10 shows the operation flow of the source radio base station according to Operation Example 5. As shown in FIG. 10, the source radio base station (radio base station 100) determines whether the UE 200 to be handed over is an aerial UE (S 210).

The determination of whether the UE is an aerial UE may be made according to the information shown explicitly or implicitly in the handover message or according to information provided by the network.

For example, the radio base station 100 may (or may) determine that the UE 200 is an aerial UE if at least either of the multipleCellsMeasExtension-r 15 or heightMeas-r 15 (see 3 GPP TS 38.331) is shown as the capability information (UE capability) of the UE 200 transmitted from the UE 200.

Alternatively, if the radio base station 100 is notified of Aerial UE subscription information in the INITIAL CONTEXT SETUP REQUEST msg. or UE CONTEXT MODIFICATION REQUEST msg. sent from the network device 40, it may (or may) determine that the UE 200 is an Aerial UE.

If the UE 200 is an Aerial UE, the radio base station 100 may exclude the frequency band where the Aerial UE is limited from the measurement target of the UE 200 (S 220).

Specifically, when configuration the measurement configuration (measConfig) of the UE 200, the radio base station 100 may not set the frequency band (band) where the Aerial UE is limited as the measurement target (measObject). Alternatively, the radio base station 100 may add cells of the frequency of the band where the Aerial UE is limited to the black cells of the measObject.

### (3.2.6) Operation Example 6

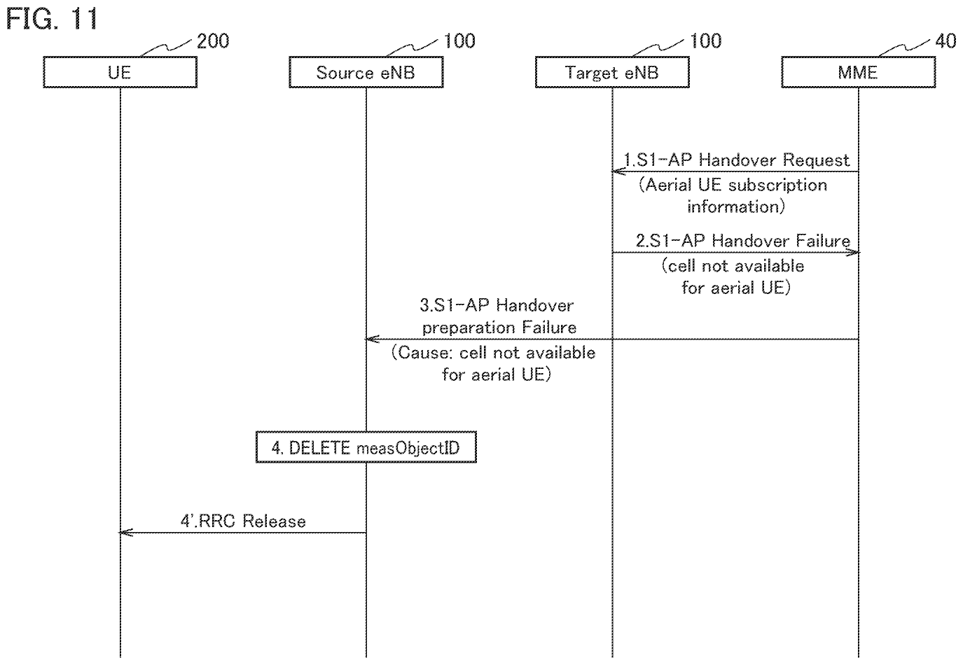

FIG. 11 shows an example of the communication sequence of the S1 handover according to Example 6. As shown in FIG. 11, the network device 40 can transmit a Handover Request msg. containing Aerial UE subscription information to the target radio base station (radio base station 100) (Step 1).

If the target radio base station receives a Handover Request containing Aerial UE subscription information, it may return a Handover Failure msg. containing the cell not available for aerial UE to network device 40 (step 2). Specifically, the cell not available for aerial UE may be included as a cause of the Handover Failure.

The network device 40 may send a Handover Preparation Failure msg. containing the cell not available for aerial UE to the source radio base station (step 3).

If the source radio base station (radio base station 100) receives a Handover Preparation Failure msg. containing the cell not available for aerial UE, it may delete the measObjectID of the UE 200 subject to the handover.

Specifically, the radio base station 100 may delete the measObjectID (The target cell of the handover, that is, the frequency band that had been set by mobilityControlInfo or reconfigurationWithSync (see 3 GPP TS 38.331)) set (configured) for the UE 200 (step 4).

Alternatively, the radio base station 100 may release the UE 200 (RRC Release) (step 4′). Specifically, the radio base station 100 may send an RRC Release (or RRC Connection Release) to the UE 200.

### (4) Operational Effects

According to the above described embodiment, the following effects can be obtained. Specifically, the source radio base station (radio base station 100) determines the number of handover failures based on the Handover Preparation Failure message, and when the number of handover failures reaches a specified number, the UE 200 may be released.

Therefore, even when handover failures occur multiple times (For example, eight or more times) and NCC warp around occurs in the S1 handover, the released UE 200 may avoid a mismatch in the encryption key used by the target radio base station and the UE 200 in order to establish a connection with the radio base station again.

In this embodiment, when the source radio base station (radio base station 100) receives a Handover command message containing wrap around indication, it can send an RRC Reconfiguration containing wrap around indication to the UE 200.

In addition, if the wrap around indication is included in the reconfiguration message (For example, RRC Reconfiguration), the UE 200 may update the parameters used to generate the cryptographic key (K_{eNB}) used in the handover based on the wrap around indication.

Therefore, in the S1 handover, even if the handover failure occurs multiple times (For example, eight or more times) and the NCC warp around occurs, the UE 200 can update to an appropriate NH value, thereby avoiding a mismatch between the cryptographic key used by the target radio base station and the UE 200.

In this embodiment, the source radio base station (radio base station 100) may release the UE 200 when it receives the wrap around indication contained in the Handover Preparation Failure message.

Therefore, even if handover failure occurs multiple times (For example, eight or more times) and NCC warp around occurs in the S1 handover, the released UE 200 can avoid a mismatch in the encryption key used by the target radio base station and the UE 200 in order to re-establish connection with the radio base station.

In this embodiment, the source radio base station (radio base station 100) may change the configuration regarding the measurement object (measObject) of the UE 200 when the number of times the Handover Preparation Failure message is received reaches a specified value.

Therefore, in the S1 handover, even if handover failure occurs multiple times (For example, eight or more times) and NCC warp around occurs, the target radio base station is excluded because the measObjectID can be deleted or the cell to which the handover is to be applied, corresponding to the Handover Preparation Failure message, can be added as a source radio base station (cell) as a black cell in the measObject. This can avoid the mismatch of the encryption key used in the target radio base station and the UE 200.

In this embodiment, the source radio base station (radio base station 100) and the network device 40 can exclude the frequency band where the Aerial UE is limited from the measurement target of the UE 200 if the UE 200 is an Aerial UE.

### (5) Other Embodiments

Although the above description of the embodiment is not limited to the description of the embodiment, it is obvious to those skilled in the art that various modifications and improvements are possible.

For example, in the above embodiment, LTE and NR have been described without distinguishing them clearly, but the above operation related to avoiding mismatch of encryption keys is applicable to both LTE and NR.

In addition, the above actions related to avoiding mismatch of encryption keys may be applied to one specific UE. That is, when multiple UEs perform S1 handover, the actions may be performed for each UE.

In addition, the block configuration diagrams (FIGS. 2 and 3) used to explain the above embodiment show blocks for each functional unit. Those functional blocks (structural components) can be realized by a desired combination of at least one of hardware and software. Means for realizing each functional block is not particularly limited. That is, each functional block may be realized by one device combined physically or logically. Alternatively, two or more devices separated physically or logically may be directly or indirectly connected (for example, wired, or wireless) to each other, and each functional block may be realized by these plural devices. The functional blocks may be realized by combining software with the one device or the plural devices mentioned above.

Functions include judging, deciding, determining, calculating, computing, processing, deriving, investigating, searching, confirming, receiving, transmitting, outputting, accessing, resolving, selecting, choosing, establishing, comparing, assuming, expecting, considering, broadcasting, notifying, communicating, forwarding, configuring, reconfiguring, allocating (mapping), assigning, and the like. However, the functions are not limited thereto. For example, the functional block (component) that makes transmission work is called a transmitting unit (transmission unit) or transmitter. In either case, as described above, the implementation method is not particularly limited.

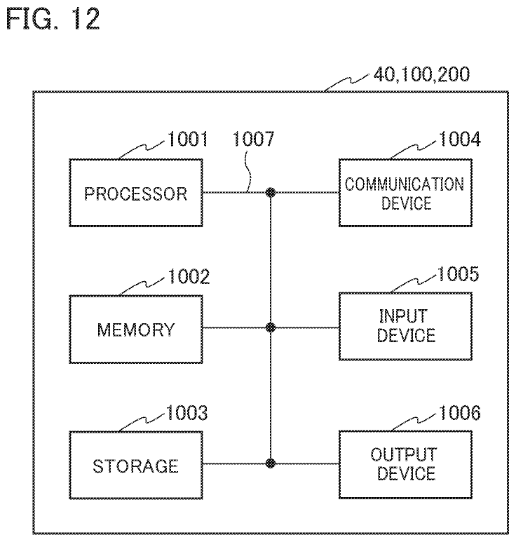

Furthermore, the network device 40, the radio base station 100 and the UE 200 (the device) described above may function as a computer for processing the radio communication method of this disclosure. FIG. 12 shows an example of the hardware configuration of the device. As shown in FIG. 12, the device may be configured as a computer device including a processor 1001, a memory 1002, a storage 1003, an communication device 1004, an input device 1005, an output device 1006, a bus 1007, etc.

Furthermore, in the following explanation, the term “device” can be replaced with a circuit, device, unit, and the like. Hardware configuration of the device can be constituted by including one or plurality of the devices shown in the figure, or can be constituted by without including a part of the devices.

Each functional block of the device (see FIG. 2.3) is realized by any hardware element of the computer device or a combination of the hardware elements.

Moreover, the processor 1001 performs computing by loading a predetermined software (computer program) on hardware such as the processor 1001 and the memory 1002, and realizes various functions of the reference device by controlling communication via the communication device 1004, and controlling reading and/or writing of data on the memory 1002 and the storage 1003.

The processor 1001 controls the entire computer by, for example, operating the operating system. The processor 1001 may consist of a central processing unit (CPU) including interfaces with peripheral devices, controllers, arithmetic units, registers, etc.

Moreover, the processor 1001 reads a computer program (program code), a software module, data, and the like from the storage 1003 and/or the communication device 1004 into the memory 1002, and executes various processes according to the data. As the computer program, a computer program that is capable of executing on the computer at least a part of the operation explained in the above embodiments is used. Alternatively, various processes explained above can be executed by one processor 1001 or can be executed simultaneously or sequentially by two or more processors 1001. The processor 1001 can be implemented by using one or more chips. Alternatively, the computer program can be transmitted from a network via a telecommunication line.

The memory 1002 is a computer readable recording medium and is configured, for example, with at least one of Read Only Memory (ROM), Erasable Programmable ROM (EPROM), Electrically Erasable Programmable ROM (EEPROM), Random Access Memory (RAM), and the like. Memory 1002 may be referred to as a register, cache, main memory, etc. Memory 1002 may store programs (program code), software modules, etc., that are capable of executing a method according to one embodiment of this disclosure.

The storage 1003 is a computer readable recording medium. Examples of the storage 1003 include an optical disk such as Compact Disc ROM (CD-ROM), a hard disk drive, a flexible disk, a magneto-optical disk (for example, a compact disk, a digital versatile disk, Blu-ray (Registered Trademark) disk), a smart card, a flash memory (for example, a card, a stick, a key drive), a floppy (Registered Trademark) disk, a magnetic strip, and the like. The storage 1003 can be called an auxiliary storage device. The recording medium can be, for example, a database including the memory 1002 and/or the storage 1003, a server, or other appropriate medium.

The communication device 1004 is hardware (transmission/reception device) capable of performing communication between computers via a wired and/or wireless network. The communication device 1004 is also called, for example, a network device, a network controller, a network card, a communication module, and the like.

The communication device 1004 includes a high-frequency switch, a duplexer, a filter, a frequency synthesizer, and the like in order to realize, for example, at least one of Frequency Division Duplex (FDD) and Time Division Duplex (TDD).

The input device 1005 is an input device (for example, a keyboard, a mouse, a microphone, a switch, a button, a sensor, and the like) that accepts input from the outside. The output device 1006 is an output device (for example, a display, a speaker, an LED lamp, and the like) that outputs data to the outside. Note that, the input device 1005 and the output device 1006 may be integrated (for example, a touch screen).

Each device such as a processor 1001 and a memory 1002 is connected by a bus 1007 for communicating information. The bus 1007 may be configured using a single bus or different buses for each device.

Furthermore, the device may be configured including hardware such as a microprocessor, a digital signal processor (DSP), an application specific integrated circuit (ASIC), a programmable logic device (PLD), a field programmable gate array (FPGA), etc., with which some or all of the functional blocks may be implemented. For example, the processor 1001 may be implemented by using at least one of these hardware.

Also, the notification of information is not limited to the mode/embodiment described in this disclosure and may be made using other methods. For example, the notification of information may be carried out by physical layer signaling (e.g., Downlink Control Information (DCI), Uplink Control Information (UCI), higher layer signaling (e.g., RRC signaling, Medium Access Control (MAC) signaling, notification information (Master Information Block (MIB), System Information Block (SIB)), other signals or a combination thereof. The RRC signaling may also be referred to as an RRC message, e.g., an RRC Connection Setup message, an RRC Connection Reconfiguration message, etc.

Each of the above aspects/embodiments can be applied to at least one of Long Term Evolution (LTE), LTE-Advanced (LTE-A), SUPER 3G, IMT-Advanced, 4th generation mobile communication system (4G), 5th generation mobile communication system (5G), Future Radio Access (FRA), New Radio (NR), W-CDMA (Registered Trademark), GSM (Registered Trademark), CDMA2000, Ultra Mobile Broadband (UMB), IEEE 802.11 (Wi-Fi (Registered Trademark)), IEEE 802.16 (WiMAX (Registered Trademark)), IEEE 802.20, Ultra-WideBand (UWB), Bluetooth (Registered Trademark), a system using any other appropriate system, and a next-generation system that is expanded based on these. Further, a plurality of systems may be combined (for example, a combination of at least one of the LTE and the LTE-A with the 5G).

The processing procedures, sequences, flowcharts, etc., of each mode/embodiment described in this disclosure may be reordered as long as there is no conflict. For example, the method described in this disclosure uses an illustrative order to present elements of various steps and is not limited to the specific order presented.

The specific operation that is performed by the base station in the present disclosure may be performed by its upper node in some cases. In a network constituted by one or more network nodes having a base station, the various operations performed for communication with the terminal may be performed by at least one of the base station and other network nodes other than the base station (for example, MME, S-GW, and the like may be considered, but not limited thereto). In the above, an example in which there is one network node other than the base station is explained; however, a combination of a plurality of other network nodes (for example, MME and S-GW) may be used.

Information, signals (information and the like) can be output from an upper layer (or lower layer) to a lower layer (or upper layer). It may be input and output via a plurality of network nodes.

The input/output information can be stored in a specific location (for example, a memory) or can be managed in a management table. The information to be input/output can be overwritten, updated, or added. The information can be deleted after outputting. The inputted information can be transmitted to another device.

The determination may be made by a value (0 or 1) represented by one bit or by Boolean value (Boolean: true or false), or by comparison of numerical values (for example, comparison with a predetermined value).

Each aspect/embodiment described in this disclosure may be used alone, in combination, or switched over as practice progresses. In addition, notification of predetermined information (for example, notification of “being X”) is not limited to being performed explicitly, it may be performed implicitly (for example, without notifying the predetermined information).

Instead of being referred to as software, firmware, middleware, microcode, hardware description language, or some other name, software should be interpreted broadly to mean instruction, instruction set, code, code segment, program code, program, subprogram, software module, application, software application, software package, routine, subroutine, object, executable file, execution thread, procedure, function, and the like.

Further, software, instruction, information, and the like may be transmitted and received via a transmission medium. For example, when a software is transmitted from a website, a server, or some other remote source by using at least one of a wired technology (coaxial cable, fiber optic cable, twisted pair, Digital Subscriber Line (DSL), or the like) and a wireless technology (infrared light, microwave, or the like), then at least one of these wired and wireless technologies is included within the definition of the transmission medium.

Information, signals, or the like mentioned above may be represented by using any of a variety of different technologies. For example, data, instruction, command, information, signal, bit, symbol, chip, or the like that may be mentioned throughout the above description may be represented by voltage, current, electromagnetic wave, magnetic field or magnetic particle, optical field or photons, or a desired combination thereof.

It should be noted that the terms described in this disclosure and terms necessary for understanding the present disclosure may be replaced by terms having the same or similar meanings. For example, at least one of the channels and symbols may be a signal (signaling). Also, the signal may be a message. Also, a signal may be a message. Further, a component carrier (Component Carrier: CC) may be referred to as a carrier frequency, a cell, a frequency carrier, or the like.

The terms “system” and “network” used in the present disclosure can be used interchangeably.

Furthermore, the information, the parameter, and the like explained in the present disclosure can be represented by an absolute value, can be expressed as a relative value from a predetermined value, or can be represented by corresponding other information. For example, the radio resource can be indicated by an index.

The name used for the above parameter is not a restrictive name in any respect. In addition, formulas and the like using these parameters may be different from those explicitly disclosed in the present disclosure. Because the various channels (for example, PUCCH, PDCCH, or the like) and information element can be identified by any suitable name, the various names assigned to these various channels and information elements shall not be restricted in any way.

In the present disclosure, it is assumed that “base station (Base Station: BS),” “radio base station,” “fixed station,” “NodeB,” “eNodeB (eNB),” “gNodeB (gNB),” “access point,” “transmission point,” “reception point,” “transmission/reception point,” “cell,” “sector,” “cell group,” “carrier,” “component carrier,” and the like can be used interchangeably. The base station may also be referred to with the terms such as a macro cell, a small cell, a femtocell, or a pico cell.

The base station can accommodate one or more (for example, three) cells (also called sectors). In a configuration in which the base station accommodates a plurality of cells, the entire coverage area of the base station can be divided into a plurality of smaller areas. In each such a smaller area, communication service can be provided by a base station subsystem (for example, a small base station for indoor use (Remote Radio Head: RRH)).

The term “cell” or “sector” refers to a part or all of the coverage area of a base station and/or a base station subsystem that performs communication service in this coverage.

In the present disclosure, the terms “mobile station (Mobile Station: MS),” “user terminal,” “user equipment (User Equipment: UE),” “terminal” and the like can be used interchangeably.

The mobile station is called by the persons skilled in the art as a subscriber station, a mobile unit, a subscriber unit, a radio unit, a remote unit, a mobile device, a radio device, a radio communication device, a remote device, a mobile subscriber station, an access terminal, a mobile terminal, a radio terminal, a remote terminal, a handset, a user agent, a mobile client, a client, or with some other suitable term.

At least one of a base station and a mobile station may be called a transmitting device, a receiving device, a communication device, or the like. Note that, at least one of a base station and a mobile station may be a device mounted on a moving body, a moving body itself, or the like. The mobile body may be a vehicle (For example, cars, airplanes, etc.), an unmanned mobile body (For example, drones, self-driving cars, etc.) or a robot (manned or unmanned). At least one of a base station and a mobile station can be a device that does not necessarily move during the communication operation. For example, at least one of a base station and a mobile station may be an Internet of Things (IoT) device such as a sensor.

The base station in this disclosure may also be read as a mobile station (user terminal, hereinafter the same). For example, each mode/embodiment of this disclosure may be applied to a configuration in which communication between a base station and a mobile station is replaced with communication between multiple mobile stations (For example, it may be called Device-to-Device (D2D), Vehicle-to-Everything (V2X), etc.). In this case, the mobile station may have the function of the base station. In addition, words such as “up” and “down” may be replaced with words corresponding to communication between terminals (For example, “side”). For example, terms an uplink channel, a downlink channel, or the like may be read as a side channel.

similarly, mobile stations in this disclosure may be replaced with base stations. In this case, the base station may have the function of the mobile station. A radio frame may be composed of one or more frames in the time domain. Each frame or frames in the time domain may be referred to as a subframe. A subframe may be further configured by one or more slots in the time domain. Subframes may have a fixed length of time (For example, 1 ms) independent of numerology.

Numerology may be a communication parameter applied to at least one of transmission and reception of a certain signal or channel. The numerology can include one among, for example, subcarrier spacing (SubCarrier Spacing: SCS), bandwidth, symbol length, cyclic prefix length, transmission time interval (Transmission Time Interval: TTI), number of symbols per TTI, radio frame configuration, a specific filtering process performed by a transceiver in the frequency domain, a specific windowing process performed by a transceiver in the time domain, and the like.

The slot may be configured with one or a plurality of symbols (Orthogonal Frequency Division Multiplexing (OFDM)) symbols, Single Carrier Frequency Division Multiple Access (SC-FDMA) symbols, etc.) in the time domain. A slot may be a unit of time based on the numerology.

A slot may include a plurality of minislots. Each minislot may be configured with one or more symbols in the time domain. A minislot may also be called a subslot. A minislot may be composed of fewer symbols than slots. A PDSCH (or PUSCH) transmitted in units of time larger than a minislot may be called a PDSCH (or PUSCH) mapping type A. PDSCH (or PUSCH) transmitted using a minislot may be referred to as PDSCH (or PUSCH) mapping type B.

Each of the radio frame, subframe, slot, minislot, and symbol represents a time unit for transmitting a signal. Different names may be used for the radio frame, subframe, slot, minislot, and symbol.

For example, one subframe may be called a transmission time interval (TTI), a plurality of consecutive subframes may be called TTI, and one slot or one minislot may be called TTI. That is, at least one of the subframes and TTI may be a subframe (1 ms) in an existing LTE, may have a duration shorter than 1 ms (For example, 1-13 symbols), or may have a duration longer than 1 ms. Note that, a unit representing TTI may be called a slot, a minislot, or the like instead of a subframe.

Here, TTI refers to the minimum time unit of scheduling in radio communication, for example. Here, TTI refers to the minimum time unit of scheduling in radio communication, for example. For example, in the LTE system, the base station performs scheduling for allocating radio resources (frequency bandwidth, transmission power, etc. that can be used in each user terminal) to each user terminal in units of TTI. The definition of TTI is not limited to this.

The TTI may be a transmission time unit such as a channel-encoded data packet (transport block), a code block, or a code word, or may be a processing unit such as scheduling or link adaptation. When TTI is given, a time interval (for example, the number of symbols) in which a transport block, a code block, a code word, etc. are actually mapped may be shorter than TTI.

When one slot or one minislot is called TTI, one or more TTIs (that is, one or more slots or one or more minislots) may be the minimum scheduling unit. In addition, the number of slots (number of minislots) constituting the minimum time unit of the scheduling may be controlled.

TTI having a time length of 1 ms may be referred to as an ordinary TTI (TTI in LTE Rel. 8-12), a normal TTI, a long TTI, a normal subframe, a normal subframe, a long subframe, a slot, and the like. TTI shorter than the ordinary TTI may be referred to as a shortened TTI, a short TTI, a partial TTI (partial or fractional TTI), a shortened subframe, a short subframe, a minislot, a subslot, a slot, and the like.

In addition, a long TTI (for example, ordinary TTI, subframe, etc.) may be read as TTI having a time length exceeding 1 ms, and a short TTI (for example, shortened TTI) may be read as TTI having TTI length of less than the TTI length of the long TTI but TTI length of 1 ms or more.

The resource block (RB) is a resource allocation unit in the time domain and frequency domain, and may include one or a plurality of continuous subcarriers in the frequency domain. The number of subcarriers included in RB may be, for example, twelve, and the same regardless of the topology. The number of subcarriers included in the RB may be determined based on the neurology.

Also, the time domain of RB may include one or a plurality of symbols, and may have a length of 1 slot, 1 minislot, 1 subframe, or 1 TTI. Each TTI, subframe, etc. may be composed of one or more resource blocks.

Note that, one or more RBs may be called a physical resource block (Physical RB: PRB), a subcarrier group (SubCarrier Group: SCG), a resource element group (Resource Element Group: REG), PRB pair, RB pair, etc.

A resource block may be configured by one or a plurality of resource elements (Resource Element: RE). For example, one RE may be a radio resource area of one subcarrier and one symbol.

A bandwidth part (BWP) (which may be called a partial bandwidth, etc.) may represent a subset of contiguous common resource blocks (RBs) for a certain neurology in a certain carrier. Here, the common RB may be identified by an index of RBs relative to the common reference point of the carrier. PRB may be defined in BWP and numbered within that BWP.

BWP may include UL BWP (UL BWP) and DL BWP (DL BWP). One or a plurality of BWPs may be configured in one carrier for the UE.

At least one of the configured BWPs may be active, and the UE may not expect to send and receive certain signals/channels outside the active BWP. Note that “cell,” “carrier,” and the like in this disclosure may be read as “BWP.”

The above-described structures such as a radio frame, subframe, slot, minislot, and symbol are merely examples. For example, the number of subframes included in a radio frame, the number of slots per subframe or radio frame, the number of minislots included in a slot, the number of symbols and RBs included in a slot or minislot, the subcarriers included in RBs, and the number of symbols included in TTI, a symbol length, the cyclic prefix (CP) length, and the like can be changed in various manner.

The terms “connected,” “coupled,” or any variations thereof, mean any direct or indirect connection or coupling between two or more elements. Also, one or more intermediate elements may be present between two elements that are “connected” or “coupled” to each other. The coupling or connection between the elements may be physical, logical, or a combination thereof. For example, “connection” may be read as “access.” In the present disclosure, two elements can be “connected” or “coupled” to each other by using one or more wires, cables, printed electrical connections, and as some non-limiting and non-exhaustive examples, by using electromagnetic energy having wavelengths in the microwave region and light (both visible and invisible) regions, and the like.

The reference signal may be abbreviated as Reference Signal (RS) and may be called pilot (Pilot) according to applicable standards.

As used in the present disclosure, the phrase “based on” does not mean “based only on” unless explicitly stated otherwise. In other words, the phrase “based on” means both “based only on” and “based at least on.”

The “means” in the configuration of each apparatus may be replaced with “unit,” “circuit,” “device,” and the like.

Any reference to an element using a designation such as “first,” “second,” and the like used in the present disclosure generally does not limit the amount or order of those elements. Such designations can be used in the present disclosure as a convenient way to distinguish between two or more elements. Thus, the reference to the first and second elements does not imply that only two elements can be adopted, or that the first element must precede the second element in some or the other manner.

In the present disclosure, the used terms “include,” “including,” and variants thereof are intended to be inclusive in a manner similar to the term “comprising.” Furthermore, the term “or” used in the present disclosure is intended not to be an exclusive disjunction.

Throughout this disclosure, for example, during translation, if articles such as a, an, and the in English are added, in this disclosure, these articles shall include plurality of nouns following these articles.

As used in this disclosure, the terms “determining,” “judging” and “deciding” may encompass a wide variety of actions. “Judgment” and “decision” includes judging or deciding by, for example, judging, calculating, computing, processing, deriving, investigating, looking up, search, inquiry (e.g., searching in a table, database, or other data structure), ascertaining, and the like. In addition, “judgment” and “decision” can include judging or deciding by receiving (for example, receiving information), transmitting (for example, transmitting information), input (input), output (output), and access (accessing) (e.g., accessing data in a memory). In addition, “judgement” and “decision” can include judging or deciding by resolving, selecting, choosing, establishing, and comparing. That is, “judgment” and “determination” may include regarding some action as “judgment” and “determination.” Moreover, “judgment (decision)” may be read as “assuming,” “expecting,” “considering,” and the like.

In the present disclosure, the term “A and B are different” may mean “A and B are different from each other.” It should be noted that the term may mean “A and B are each different from C.” Terms such as “leave,” “coupled,” or the like may also be interpreted in the same manner as “different.”

Although the present disclosure has been described in detail above, it will be obvious to those skilled in the art that the present disclosure is not limited to the embodiments described in this disclosure. The present disclosure can be implemented as modifications and variations without departing from the spirit and scope of the present disclosure as defined by the claims. Therefore, the description of the present disclosure is for the purpose of illustration, and does not have any restrictive meaning to the present disclosure.

### EXPLANATION OF REFERENCE NUMERALS

10 radio communication system
20 radio access network
40 network equipment
100 radio base stations
110 radio communications unit
120 handover processing unit
130 RRC processing unit
140 control unit
200 UE
210 radio communication unit
220 measurement reporting unit
230 handover execution unit
240 control unit
1001 processor
1002 memory
1003 storage
1004 communication device
1005 input device
1006 output device
1007 bus

1. A radio base station comprising:
a reception unit that receives a handover message from a network related to a handover of a terminal; and
a control unit that determines a number of the handover failures based on the handover message, and
the control unit releases the terminal when the number of failures reaches a predetermined number.

2. A radio base station comprising:
a control unit that controls transmitting and receiving of handover messages related to a handover of a terminal;
a reception unit that receives a handover message from the network, including a wraparound indication indicating that a counter value related to the handover has wraparound; and
a transmission unit that transmits a reconfiguration message including the wraparound indication to the terminal, when receiving the handover message including the wraparound indication.

3. A radio base station comprising:
a transmission unit that transmits a handover message to a network related to a handover of a terminal;
a reception unit that receives a handover message from the network including a wraparound indication indicating that a counter value related to the handover has wrapped around; and
a control unit that releases the terminal when the wraparound indication is received.

4. A radio base station comprising:
a reception unit that receives a handover message from a network related to a handover of a terminal; and
a control unit that changes configuration related to a measurement object of the terminal when a number of reception times of the handover message reaches a predetermined value.

5. The radio base station according to claim 1, wherein when the terminal is an aerial terminal, the control unit excludes a frequency band to which the aerial terminal is restricted from a measurement object of the terminal.

6. A terminal comprising:
a reception unit that receives a reconfiguration message from a network; and
a control unit that updates a parameter used to generate a cryptographic key used in a handover based on a wraparound indication if the reconfiguration message includes the wraparound indication indicating that a counter value related to the handover has wrapped around.

7. The radio base station according to claim 2, wherein when the terminal is an aerial terminal, the control unit excludes a frequency band to which the aerial terminal is restricted from a measurement object of the terminal.

8. The radio base station according to claim 3, wherein when the terminal is an aerial terminal, the control unit excludes a frequency band to which the aerial terminal is restricted from a measurement object of the terminal.

9. The radio base station according to claim 4, wherein when the terminal is an aerial terminal, the control unit excludes a frequency band to which the aerial terminal is restricted from a measurement object of the terminal.
